(19) United States
(12) Patent Application Publication
(10) Pub. No.: US 2007/0136103 A1
(43) Pub. Date: Jun. 14, 2007

(54) Method for providing medical service in hospital based on RFID

(76) Inventors: Sun-Jin Kim, Gwangju (KR); Nae-Soo Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 11/634,048

(22) Filed: Dec. 5, 2006

(30) Foreign Application Priority Data
Dec. 9, 2005 (KR) 10-2005-0121168

(51) Int. Cl. G06F 19/00; G06F 17/00; G08B 13/14; G06F 17/30; G05B 19/00

(52) U.S. Cl. 705/3; 340/572.1; 235/375; 707/1; 340/5.81

(57) ABSTRACT

Provided is a method to provide a medical service in a hospital based on Radio Frequency Identification (RFID). The method includes the steps of: a) storing diverse data to provide the service; b) extracting personal identification (ID) using an RFID reader from a RFID tag in a predetermined range; c) receiving requests through an input/output interface; d) searching the requested data among data corresponding to the extracted personal ID; and e) providing the searched data.

### FIELD OF THE INVENTION

The present invention relates to a method for providing a medical service in a hospital based on Radio Frequency Identification (RFID); more particularly, a method that provides a medical service based on RFID which easily checks diverse information in a hospital by making it easy for patients to access private medical information, e.g. personal information, medical records and reservations, and hospital guidance information, e.g. the location of the pharmacy, by using an RFID tag formatted medical card that contains their own personal identification (ID). Both information are stored in a database of a management center and processed through an RFID reader formatted interface which is located in several areas within the hospital, e.g. a lobby or hallway.

### DESCRIPTION OF RELATED ART

In general, Radio Frequency Identification (RFID) is a technology that uses electronic tags for recognizing, tracing and managing objects, animals and human beings. This is done by extracting or recording information from or onto the electronic tags that contain identification information using radio frequency without directly connecting to readers.

The RFID system consists of several RFID tags attached to materials or animals (e.g. the electronic tag or Transponder) and a RFID reader that reads or writes information from or onto the RFID tag (e.g. an interrogator).

RFID systems can be divided into a mutual inducing type and an electromagnetic wave type according to the mutual communication method between the RFID reader and tags. The RFID systems can also be divided into an active type and a passive type based on whether the RFID tag is operated with its own power source. Also, RFID systems can be divided into a long wave type, a medium wave type, a short wave type, a very high frequency type (VHF), and an ultra high frequency (UHF) type based on what frequency is used. Diverse kinds of standards are established based on the division.

A conventional medical service is conducted as follows. When a patient first visits a hospital, the hospital staff receives personal information including name, gender, age, and resident registration number through a document then inputs the personal information into a computer and builds a database. The hospital then provides the patient with a magnetic formatted medical card that contains private information. Subsequently, when the patient visits the hospital, the hospital reads the personal information recorded in the magnetic medical card through the RFID reader and refers to the past medical record. Each hospital has diverse medical departments such as the surgery and internal medicine department where patients receive medical treatment diversely. Accordingly, hospitals adopt a unified management program for efficient/synthetic management.

However, since conventional medical services use magnetic formatted medical cards, there is a problem where medical cards need to directly connect to the card reader when reading personal information.

In addition, since only a hospital manager can access card readers, which are capable of reading the medical card, patients cannot easily use their own medical record accumulated in the database even though the personal medical card is given to the patients.

A hospital related-service using the RFID based on the conventional technology is described as follows.

U.S. Patent Publication No. 2002-0058110, published on Mar. 27, 2003, discloses a radio frequency patient identification and information system. In an emergency situation, the system provides a non-fatal medical service in the state that the patient is unconscious by providing personal information and medical history of the patient which is stored in the transponder that can be placed on a wrist, ankle, in a wallet as a card/label format or hung on the neck, or transplanted under the skin of the patient.

That is, the conventional technology records all information including home address, work place address, relatives' information, current family doctor, medical history, allergy and past/present prescription medicines in the transponder which is RFID tag format in order to properly cope with the condition of the patient when an urgent situation occurs.

Since the conventional technology records diverse personal information and medical history in the transponder, there is a requirement that the memory be capable of reading/writing information of at least 2,000 bits.

Also, the conventional technology is very important in an emergency situation, but does not suggest a method that the patient can efficiently access their own medical information in general.

### SUMMARY OF THE INVENTION

Therefore, an objective of the present invention is to provide a method for providing a medical service based on Radio Frequency Identification (RFID) to easily check diverse information in a hospital by making it easy for patients to access private medical information, e.g. personal information, medical record and reservations, hospital guidance information, e.g. the location of the pharmacy, by using an RFID tag formatted medical card which contains their own personal identification (ID). Both information are collected into a database of a management center and processed through an RFID reader formatted interface which is located in several areas within the hospital, e.g. a lobby or hallway.

That is, the objective of the present invention is to provide a method for providing a medical service based on RFID which makes it easy for patients to access diverse information by a) reading their own personal ID from an RFID tag in a predetermined range using an RFID reader which is located in some areas of the hospital, b) searching for corresponding personal medical information and hospital guidance information that are stored in the database of a management center and c) providing personal medical information and hospital guidance information through an interface, e.g. a monitor.

Other objectives and advantages of the invention will be understood by the following description and will become more apparent from the embodiments in accordance with the present invention, which are set forth hereinafter. It will be also apparent that objectives and advantages of the invention can be embodied easily by the means defined in claims and combinations thereof.

In accordance with an aspect of the present invention, there is a method for providing a medical service in a hospital based on RFID, the method including the following steps of: a) storing diverse data for providing a service; b) extracting personal ID using an RFID reader from a RFID tag in a predetermined range; c) receiving requests through an input/output interface; d) searching the requested data among data corresponding to the extracted personal ID; and e) providing the searched data.

The present invention issues an RFID formatted medical card to the patient, performs a process that identifies each person with the RFID reader that is located in some areas of the hospital, checks the medical information collected in the database of the hospital through an interface, e.g., a monitor, to provide necessary information to the patient, thereby raising a level of service.

### BRIEF DESCRIPTION OF THE DRAWINGS

The above and other objects and features of the present invention will become apparent from the following description of the preferred embodiments given in conjunction with the accompanied drawings, in which:

FIG. 1 is a medical service providing system used in a hospital where the present invention is applied; and

FIG. 2 is a flowchart describing a method for providing a medical service in a hospital based on Radio Frequency Identification (RFID) in accordance with an embodiment of the present invention.

### DETAILED DESCRIPTION OF THE INVENTION

Other objectives and advantages of the present invention will become apparent using the following description of the embodiments with reference to the accompanied drawings. Therefore, those skilled in the art of the present invention can embody the technological concept and scope of the invention easily. In addition, if it is considered that the detailed description on a related art is obscure the points of the present invention, the detailed description will not be provided herein. The preferred embodiments of the present invention will be described in detail hereinafter with reference to the attached drawings.

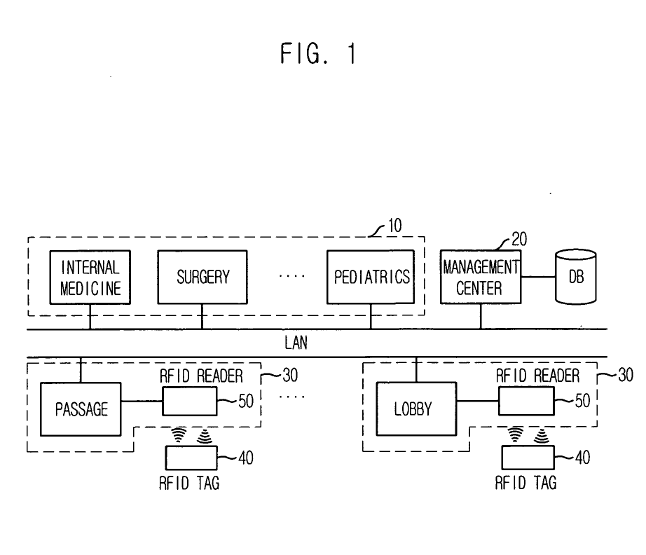

FIG. 1 is a medical service providing system used in a hospital where the present invention is applied.

The medical service providing system where the present invention is applied, includes a medical office computer system 10, a management center 20, and a computer system 30 for a patient.

The medical office computer system 10 provides an input/output interface to store diverse personal medical information such as a medical record including a diagnosis result, prescription/medication, checkup/medical treatment reservations in a database (not shown) of the management center 20 and checks the collected personal medical information.

The management center 20 synthetically manages medical information of each patient by receiving the medical information inputted by each medical office computer system 10 through a local area network (LAN), storing the medical information in the database, searching the medical information requested by the medical office computer system 10 from the database and responding to the medical office computer system 10.

The computer system 30 for the patient checks personal medical information pre-stored in the database of the management center 20, e.g., personal information, medical records and reservations, and hospital guidance information, e.g., the location of the pharmacy, upon request of the patient inputted through an RFID reader 50. General information such as hospital guidance information is also stored in the database of the management center 20.

Each medical office computer system 10 is located in diverse medical offices such as the surgery, internal medicine, and pediatrics. The computer system 30 uses the RFID reader 50 as an input device. It is located in a proper area of the hospital such as the hallway or lobby. Accordingly, the patient can easily check the personal medical information and the hospital guidance information accumulated in the database of the hospital. Each medical office computer system 10 and each computer system 30 are connected to the management center 20 through a LAN and a unified management program is stationed in the medical office computer system 10.

An RFID tag 40 provided to the patient as a medical card is read by the RFID reader 50 located in some areas of the hospital and used to check a patient's identity. That is, the RFID tag 40 stores personal identification (ID) for the patient. The RFID tag 40 can also store other personal information such as name, age, gender distinction, and resident registration number.

The RFID reader 50 operates as an input device of the computer system 30 located in some areas of the hospital, e.g., the hallway or lobby. That is, the RFID reader 50 reads personal ID that is stored in the RFID tag 40 in a predetermined range and transmits the personal ID to the computer system 30. Accordingly, the computer system 30 can identify the patient and perform a next operating procedure.

The computer system 30 receives a predetermined personal ID from the connected RFID reader 50 and provides an interface such as a keyboard or a touch screen to input security information pre-registered according to each person. Herein, security information of each person means diverse information required for a personal certification process such as a password or a finger print.

The computer system 30 requests security information corresponding to the personal ID that is pre-inputted using the RFID reader 50 to the management center 20 and receives the security information. Subsequently, the computer system 30 determines whether the security information corresponding to the personal ID is the same as personal security information inputted from the outside such as the password or finger print.

When the security information corresponding to the personal ID is not identical to the personal security information inputted from the outside, the computer system 30 prohibits access to the personal medical information. The computer system 30 can be realized to permit the access to general information such as hospital guidance information, e.g., a guide map for each place of the hospital such as the location of the pharmacy.

When the security information corresponding to the personal ID is identical to the personal security information inputted from the outside, the computer system 30 receives items requiring search and check through an interface. Subsequently, the computer system 30 requests corresponding data to the management center 20, receives the data and outputs the data to the outside.

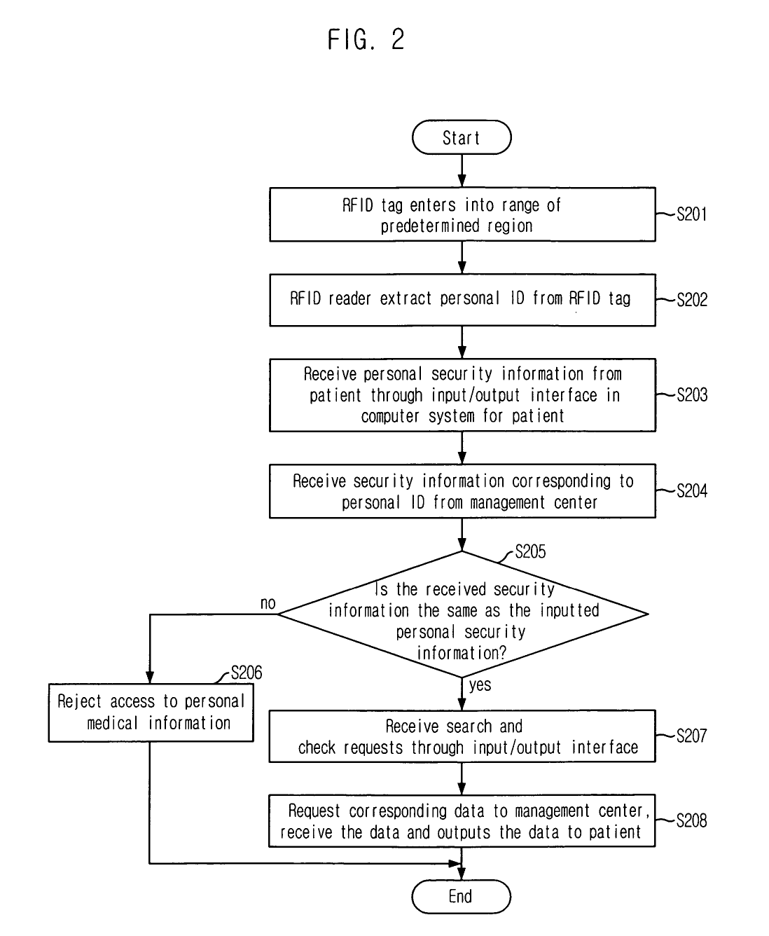

FIG. 2 is a flowchart describing a method for providing a medical service in a hospital based on RFID in accordance with an embodiment of the present invention.

The personal medical information and the hospital guidance information of each patient are stored in the database of the management center 20. That is, the management center 20 stores diverse medical records which are inputted through the medical office computer system 10 in the database. The management center 20 also stores the information inputted through a reception desk (not shown), e.g., the personal ID given to the patient at first visit.

When the RFID tag 40 enters a predetermined range at step S201, the RFID reader 50 of the computer system 30 communicates with the RFID tag 40 and extracts the personal ID of the patient at step S202.

That is, the RFID reader 50 detects the RFID tag 40 in a predetermined radius at a regular time interval. When the RFID tag 40 is present, the RFID reader 50 receives personal ID from the RFID tag 40.

The computer system 30 receives personal security information from an outpatient through an input/output interface at step S203. That is, the computer system 30 receives a password from the patient through a keyboard or a touch screen. The finger print can be used as the security information.

The computer system 30 receives security information corresponding to the personal ID extracted as a result of the request to the management center 20 at step S204, and determines at step S205 whether the received security information is identical to the inputted personal security information. That is, the computer system 30 determines whether the password pre-registered in the database is the same as the password directly inputted from the patient. It is a person's identity check procedure to prevent outflow of personal information.

When the received security information is not identical to the inputted personal security information, the computer system 30 prohibits access to the personal medical information at step S206. The computer system 30 can permit access to general information such as hospital guidance information, e.g., a guide map. Also, the computer system 30 can go back to the security information inputting procedure of step S203.

When the received security information is identical to the inputted personal security information, the computer system 30 receives items requiring search and checks through an input/output interface at step S207. The computer system 30 requests corresponding data to the management center 20, receives the data and outputs the data to the outside through a monitor at step S208.

That is, the computer system 30 searches the database of the management center 20 and provides the requested medical record of the patient, e.g., a diagnosis result, prescription/medication, checkup/medical treatment reservations, and hospital guidance information.

For example, when the patient selects a prescription item through the touch screen, the computer system 30 displays the location, i.e., an outline map of the pharmacy so that the patient can easily find the pharmacy. The current location and the pharmacy's location can be checked by allowing an ID code to the RFID reader. Each place can be identified by allowing the ID code to each place of the hospital included in the guide map.

When a service connected to internal institutes and external institutes is provided, the computer system 30 can select the service through the touch screen. For example, when an external pharmacy compounds a medicine, the patient selects the service item and the prescription is automatically transmitted to the pre-registered and designated pharmacy.

A second example can be, when the patient selects a checkup item through the touch screen, the location, e.g., an outline map of the lab and the checkup available time are displayed.

Also, when the patient selects a reservation item through the touch screen, a reservation receipt date and the medical departments are displayed.

The patient can easily check personal medical information and hospital guidance information through a predetermined input/output interface by approaching the RFID tag formatted medical card to the RFID reader located in some areas of the hospital through the present invention. Accordingly, the present invention can improve the quality of the hospital service.

As described above, the technology of the present invention can be realized as a program and stored in a computer-readable recording medium, such as CD-ROM, RAM, ROM, floppy disk, hard disk or magneto-optical disk. Since the process can be easily implemented by those skilled in the art of the present invention, further description will not be provided herein.

The present application contains subject matter related to Korean patent application No. 2005-0121168, filed with the Korean Intellectual Property Office on Dec. 9, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A method for providing a medical service in a hospital based on Radio Frequency Identification (RFID), comprising the steps of:
a) storing diverse data to provide a medical service;
b) extracting personal identification (ID) using an RFID reader from a RFID tag in a predetermined range;
c) receiving requests through an input/output interface;
d) searching the requested data among data corresponding to the extracted personal ID; and
e) providing the searched data.

2. The method as recited in claim 1, further comprising the steps of:
f) receiving personal security information through the input/output interface; and
g) checking whether the security information corresponding to the extracted personal ID is identical to the inputted security information.

3. The method as recited in claim 2, wherein the security information includes at least one between a password or finger print.

4. The method as recited in claim 1, wherein in step e), the searched data is outputted through the input/output interface.

5. The method as recited in claim 1, wherein in step e), when a predetermined service is requested among services connected to internal institutes and external institutes, the searched data are automatically transmitted to a corresponding institute.

6. The method as recited in claim 5, wherein in step e), prescription is searched and automatically transmitted to the designated pharmacy.

7. The method as recited in claim 1, wherein in step d), the requested data among personal medical information and hospital guidance information are searched from the database.

8. The method as recited in claim 7, wherein in step d), the database is searched for the requested data among personal information, medical record, reservations, and a guide map.

9. The method as recited in claim 1, wherein input/output interface includes at least one among a touch screen, keyboard, monitor, or a finger print reader.
